(19) United States
(12) Patent Application Publication
(10) Pub. No.: US 2011/0282490 A1
(43) Pub. Date: Nov. 17, 2011

(54) CONTROL DEVICE AND METHOD FOR SAFETY MONITORING OF MANIPULATORS

(76) Inventors: Peter Weigele, Horgau (DE); Uwe Bonin, Friedberg (DE); Heinrich Munz, Bergatreute (DE); Thomas Finsterwalder, Augsburg (DE)

(21) Appl. No.: 13/109,136

(22) Filed: May 17, 2011

(30) Foreign Application Priority Data
May 17, 2010 (DE) 10 2010 020 750.0

(51) Int. Cl. G05B 19/048; H02H 11/00

(52) U.S. Cl. 700/250; 307/326

(57) ABSTRACT

For individual safety monitoring of a manipulator by a control device, a part of the control device is configured by the manufacturer and a part of the control device is configured by a user. The manufacturer-configured part ensures a basic safety functionality of the manipulator independent of a user configuration; and/or a safety device of a control device for individual safety monitoring of a manipulator communicates with a control device for individual safety monitoring of an additional manipulator of a manipulator arrangement for superordinate safety monitoring of the manipulator arrangement.

### BACKGROUND OF THE INVENTION

1. Field of the Invention

The present invention concerns a device, a system and a method for safety monitoring of manipulators, in particular robots.

2. Description of the Prior Art

A robot control unit for monitoring the inherent safety of an industrial robot that, for example, exhibits a safe braking, stopping, movement with reduced velocity or occupying an absolute position is known from DE 10 2006 000 635 A1, which is representative of this type of control unit. For this purpose, in addition to a robot controller (that, for example, commands the robot path) and an actuator drive technology (to translate the control commands of the robot controller) the robot control unit has a safety controller in the control cabinet of the robot. This safety controller is connected in a secure manner with external peripheral safety components such as an emergency off switch and the actuator technology. It is functionally and physically separated by an SPC (“stored program control”) that ensures a superordinate (hierarchical) cellular safety. Both this SPS and the individual robot control units are freely configurable by the user in order to enable the highest degree of flexibility.

### SUMMARY OF THE INVENTION

It is the object of the present invention to improve a manipulator safety monitoring according to the above type.

A control device according to the invention is configured for individual safety monitoring or monitoring of the inherent safety of a manipulator, in particular of a robot (such as an industrial robot).

As used herein, individual or inherent safety monitoring means monitoring of the manipulator independently of its environment, in particular independently of additional manipulators that (for example) are arranged in a common automation cell, in particular a production or installation cell.

Such monitoring can have one or more manipulator state-related safety functionalities, for instance a safe monitoring of the pose and/or velocity of the manipulator in the joint or actuator coordinate space, or in Cartesian or working space. Such monitoring can include the safe monitoring of a working, recording and/or protection space and/or a reduced velocity that is provided (for example in the setup operation) to protect operating personnel, manipulator and environment. Additionally or alternatively, the individual or inherent safety monitoring can monitor, for example, forces and moments acting on the manipulator and/or exerted by it, for example contact forces with the environment or actuation torques. Additionally or alternatively, the individual or inherent safety monitoring can also monitor external (in particular manipulator-specific) peripheral safety components or, respectively, functionalities, for instance an emergency stop, an approval input or operating type selection input or an operator protection.

More generally, as used herein, monitoring means the detection of states, for example: the manipulator pose or velocity; inputs (for example the confirmation of an affirmation button); forces or moments; a space monitoring output, for instance contact-less distance sensors (such as laser scanners) of a camera image or the like; the processing of these detected conditions or outputs; and a corresponding, predetermined reaction, for example the output of a warning, the deactivation of actuation energy, the activation of brakes, the activation of a safe retention pose, the reduction of velocities or the like.

In particular, a control device according to the invention for individual safety monitoring or to monitor the inherent safety of a manipulator can be fashioned as a robot control unit as described in DE 10 2006 000 635 A1, the entire content of which is incorporated herein by reference.

According to a first aspect of the present invention, a control device according to the invention additionally has a safety device for communication with at least one (in particular similar) control device for individual safety monitoring of an additional manipulator of a manipulator arrangement for superordinate safety monitoring of the manipulator arrangement.

According to the invention, the functional and physical separation of the inherent safety and the superordinate cellular safety monitoring via individual robot control units and an external SPC communicating with these is thus renounced, and instead of this the superordinate cellular safety monitoring is realized by a safety device that is advantageously integrated in terms of hardware and/or software into at least one control device for individual safety monitoring of a manipulator. In particular, such a safety device for superordinate safety monitoring of the manipulator arrangement and the control device for individual safety monitoring of the manipulator can be can be formed on a common hardware platform (advantageously one or more PCs) and/or with a common runtime system (preferably a safety SPS).

This aspect is based on the insight that the separate, external SPC, which has previously implemented the superordinate cellular safety monitoring, can be replaced by an additional, expansive functionality (for example corresponding hardware and/or program regions or modules) of the individual control device of one or more manipulators. Moreover, the device cost for a separate SPC is advantageously not necessary. Additionally, the common architecture of the individual inherent and/or superordinate cellular safety monitoring can reduce the requirements for the qualification of the user and improve the system integration.

Control devices for individual safety monitoring of additional manipulators of the manipulator arrangement are no longer connected with an external SPC but rather with the safety device of a control device developed according to the invention, such that no significant additional expenditure arises here. The communication between a safety device and control devices of additional manipulators and/or between a control device and its safety device preferably takes place via a common communication medium, for example a bus system. An Ethernet-based safety protocol is advantageously used.

Just like the control device for individual safety monitoring of the manipulator, the safety device can also be fashioned for superordinate safety monitoring of the manipulator arrangement to link one or more peripheral safety components or, respectively, functionalities, for instance an emergency stop or agreement input. For example, it can realize an emergency stop, a spatial monitoring or a cooperation monitoring.

According to a second aspect of the present invention that advantageously can be combined with the first aspect explained above, a control device according to the invention has a first part that can be configured only by the manufacturer as well as a second part separated from this in terms of software and hardware and communicating with it. The second part is also configurable by a user, and according to the invention the manufacturer-configured part ensures a basic safety functionality of the manipulator independent of a configuration by a user. “Manufacturer” and “user” thereby abstractly designate two different authorization levels, such that a manufacturer also encompasses suitably trained and qualified personnel of a consumer or service provider. Conversely, a user encompasses untrained and unqualified personnel of an entity that uses the manipulator for production.

Through the separation into a user-configurable part (that retains the flexibility known from DE 10 2006 000 635 A1 with freely configurable, individual safety controllers and superordinate SPC) and a manufacturer-configured part that always ensures a basic safety functionality of the manipulator independently of user configurations, a similarly flexible monitoring that is also at least partially secured against the consequences of user errors can be realized.

In particular, in combination with the first aspect of the present invention, the manufacturer-configured part for individual safety monitoring of the manipulator and the user-configurable part for superordinate safety monitoring of a manipulator arrangement can be configured so that, as with conventional external controls that can be programmed in memory by the user for cellular safety monitoring, these can be flexibly adapted by the user to the automation cell while at the same time the part that can only be configured by the manufacturer ensures basic safety functionality of the manipulator, for instance a drive force and/or contact force or contact moment limitation or a velocity monitoring. Naturally, the manufacturer-configured part can also similarly be configured at least in part for superordinate safety monitoring of a manipulator arrangement and/or the user-configurable part is at least partially set up for individual safety monitoring of the manipulator.

For example, a user configuration-independent basic safety functionality can be ensured by the manufacturer-configured part having at least one logical AND-link or OR-link with an output of the user-configurable part. For example, if a release (“Fh”) in the manufacturer-configured part with a release (“Fa”) at the output of the user-configurable part is linked by a logical AND (“̂” or, respectively, “&”) with an overall release, or a missing release or, respectively, an error signal (“ [symbol] Fh”) in the manufacturer-configured part is linked by a logical OR (“v”) with a missing release or, respectively, an error signal (“ [symbol] Fa”) at the output of the user-configurable part, the overall release independent of the configuration by a user always takes place only (even) if a release exists or is not absent in the manufacturer-configured part or, respectively, if no error signal is present there. Naturally, the AND-link or the OR-link can also be realized via an NOR-link or Peirce link, a NAND-link or Sheffer link, or exclusive (non)OR links with the complements:

| | | (Fh AND Fa) or |
|---|---|---|
| Manufacturer- | Output of the user- | not: ( [symbol] Fh OR [symbol] Fa) or |
| configured part | configurable part | ( [symbol] Fh NOR [symbol] Fa) |
| Release Fh | Release Fa | Overall release |
| Release Fh | No release or error signal | No overall release |
| | [symbol] Fa | |
| No release or error | Release Fa | No overall release |
| signal [symbol] Fh | | |
| No release or error | No release or error signal | No overall release |
| signal [symbol] Fh | [symbol] Fa | |

Additionally or alternatively, the manufacturer-configured part can have an output independent of the user-configurable part, which output always executes an emergency stop given input of an emergency stop signal by a robot controller or by an emergency off button, for example.

A control device according to the invention is advantageously integrated with a manipulator controller to command a movement of the manipulator in a manipulator control unit (in particular is implemented in this in software and/or hardware) in order to additionally reduce wiring costs.

### BRIEF DESCRIPTION OF THE DRAWINGS

FIG. 1 shows a robot arrangement with a safety monitoring according to internal operating practice.

FIG. 2 shows a robot arrangement with a safety monitoring according to one embodiment of the present invention.

FIG. 3 shows a control device of the robot arrangement according to FIG. 2.

### DESCRIPTION OF THE PREFERRED EMBODIMENTS

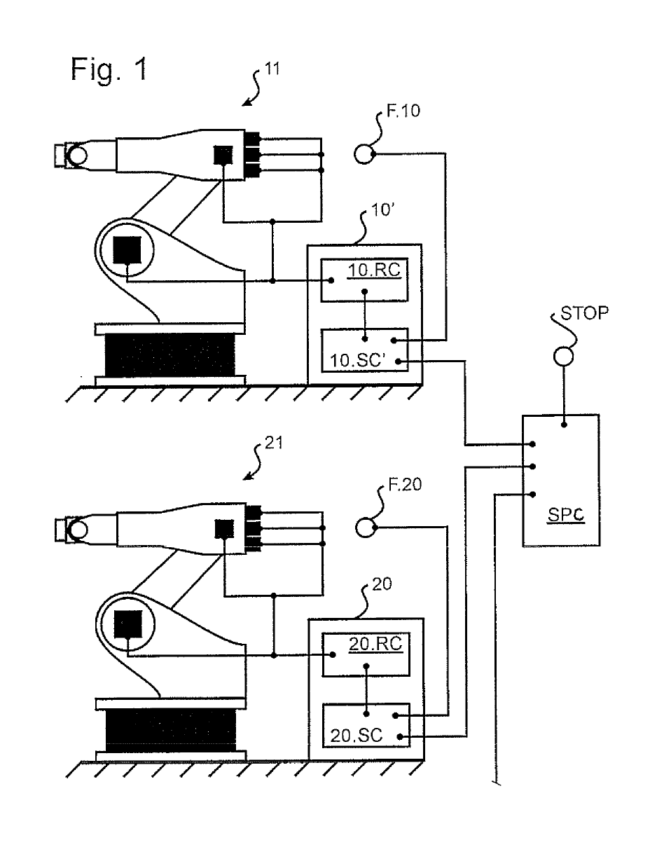

FIG. 1 shows an arrangement of multiple robots—of which only two six-axis industrial robots 11, 21 are shown—with a safety monitoring according to previous internal operating practice.

Each robot has a robot control unit 10′ or 20 that includes a robot controller and drive technology 10.RC or 20.RC, and also includes a control device 10.SC′ or 20.SC for individual or inherent safety monitoring of the respective robot 11 or 21. For example, this control device monitors the poses (attitudes) and drive torques of the respective robot and for this communicates with the respective robot controller and drive technology 10.RC or 20.RC that communicates with the drive motors of the robot (as indicated by connecting lines in FIG. 1). The control devices 10.SC′, 20.SC of the respective robots 11 and 21 are additionally respectively connected with an external confirmation button F.10 or F.20.

The control devices 10.SC′, 20.SC realize the individual or inherent safety monitoring of the respective robot 11 or 21 by monitoring its poses, drive torques and confirmation inputs F.10 or F.20 and, for example, produce a corresponding reaction—for example a STOP 0, Stop 1, STOP 2, a safe reduction of the velocity, an evasion, or recall movement or the like—upon penetration into a protected space, exceeding a maximum torque at a drive or non-activation of a confirmation button.

Additionally, according to internal operating practice an external SPC is provided that is connected with the control devices 10.SC′, 20.SC and an external emergency off button STOP at the input of a protective safety fence (not shown). This SPC that can be freely programmed by the user realizes a superordinate cellular safety monitoring and, for example, monitors whether all safety gates of the safety fence have been closed and acknowledged (not shown). If the SPC establishes an error or if it receives an error signal from one of the control devices 10.SC′, 20.SC, it reacts in the manner predetermined by the user (for example by a coordinated stop or movement of the robots 11, 21).

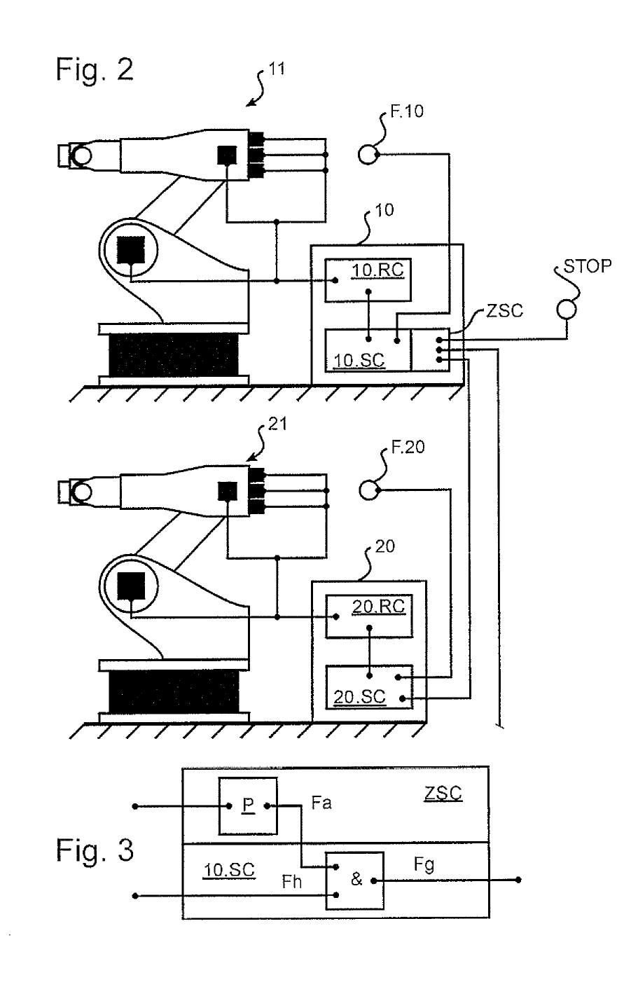

In a representation corresponding to FIG. 1, FIG. 2 shows a safety monitoring system according to one embodiment of the present invention, such that the difference relative to the internal operating practice is made clear via the synopsis with FIG. 1. Features corresponding to one another are thereby designated with the same reference characters, such that only these differences are discussed in the following.

According to the invention, a safety device ZSC is integrated into the control device 10.SC for individual safety monitoring of the robot 11 in that corresponding software and hardware modules or components are provided with a safety SPC as a common runtime system on a common hardware platform (a PC in the exemplary embodiment), which modules or, respectively, components are in particular set up to communicate with the control devices of the other robots and the external emergency off button STOP at the input of a safety fence and to realize the superordinate cellular safety monitoring of the manipulator arrangement, which was realized by the external SPC in the previous practice. For example, the ZSC integrated into the control device 10.SC henceforth monitors whether all safety gates of the safety fence have been closed and acknowledged, and whether errors signals are received by control devices 20.SC of other robots 21, and reacts accordingly by instructing the control devices 10.SC, 20.SC to produce a coordinate stop or movement of the robots 11, 21.

Like external safety peripheral components such as the emergency off button STOP, the control devices of the additional robots (of which only the control device 20.DC and the connection to an additional control device are shown in FIG. 2) can now be connected in the same manner with the safety device ZSC of the control device 10.SC instead of with the external SPS. The communication between the control devices and the safety device takes place via an Ethernet-based safety protocol.

FIG. 3 shows in section the control device 10.SC with the safety device ZSC integrated with the common runtime system on the common platform. Both are separated from one another in terms of hardware or, respectively, software (for example by different plug-in cards and/or program encapsulation) so that the control device 10.SC is fashioned as a part that can only be configured by the manufacturer; the safety device ZSC is fashioned as a part that is likewise preconfigured by the manufacturer but can also be configured by a user.

For example, the user can thus flexibly adapt the superordinate cellular safety monitoring to additional robots, safety gates or other working or, respectively, protected spaces in that he suitably reprograms a corresponding component P, for example takes into account additional inputs, provides additional links or the like.

An output of this component P (that conveys a release signal Fa of the superordinate cellular safety monitoring, for example as a result of closed and acknowledged safety gates and non-activated emergency off button STOP) is linked in an AND-link with a release signal Fh of the manufacturer-configured control device 10.SC (for example as a result of drive moment and work space limitations that are complied with) such that an overall release signal Fg that is required for an automatic operation of the robot 11, 21 is transmitted only to the control devices 10, 20 when both the release Fh of the individual or, respectively, inherent safety monitoring and the release Fa of the superordinate cellular safety monitoring are present.

If it recognized that, independent of a possibly incorrect configuration of the component P by the user, the inherent safety of the robot continues to be maintained since no overall release signal is output (due to the AND-link) given an error signal or, respectively, absence of a release signal in a part 10.SC that can only be configured by the manufacturer. In the exemplary embodiment this aspect was explained using the control device and safety device parts; however, it can also be realized in the same manner in a control device for individual safety monitoring of an individual robot in that this has a part that is configured by the manufacturer as well as a part that can be configured by a user, wherein the manufacturer-configured part ensures a basic safety functionality of the manipulator independently of the user configuration.

Although modifications and changes may be suggested by those skilled in the art, it is the intention of the inventor to embody within the patent warranted hereon all changes and modifications as reasonably and properly come within the scope of their contribution to the art.

We claim as our invention:

1. A control device for individual safety monitoring of a manipulator, said control device comprising at least one of:
a safety device configured to communicate with a further control device of a further manipulator of a manipulator arrangement that includes said manipulator, said safety device being configured for superordinate safety monitoring of all robotic manipulators in said manipulator arrangement; and
a part of a robotic manipulator that is configurable by a user, and a further part that is configured by a manufacturer to insure a basic predetermined safety functionality of said manipulator independently of user configuration of said part that is configurable by a user.

2. A control device as claimed in claim 1 comprising said safety device, and wherein said safety device is integrated by at least one of hardware or software into said control device for individual safety monitoring of the manipulator by the safety device and the control device being implemented on a common hardware platform or with a common runtime system.

3. A control device as claimed in claim 1 comprising said part configured by said manufacturer and said part configurable by a user, and wherein the part configured by the manufacturer and the user-configurable part are integrated by at least one of hardware and software, by being fashioned on a common hardware platform or with a common runtime system.

4. A control device as claimed in claim 1 comprising a safety functionality that is related to a state of the manipulator.

5. A control device as claimed in claim 1 wherein said control device or said safety device is configured for connection to a peripheral safety component.

6. A control device as claimed in claim 1 comprising said part configurable by a user and said part configured by a manufacturer, and wherein said manufacturer-configured part is configured for individual safety monitoring of the manipulator and the user-configurable part is configured for superordinate safety monitoring of the manipulator arrangement.

7. A control device as claimed in claim 6 wherein the manufacturer-configured part comprises a link with an output of said user-configurable part, said link being selected from the group consisting of an AND-link and an OR-link.

8. A control device as claimed in claim 6 wherein said manufacturer-configured part has an output that is independent of the user configurable part.

9. A method for individual safety monitoring of a manipulator, comprising at least one of:
from a safety device, communicating with a further control device of a further manipulator of a manipulator arrangement that includes said manipulator, and with said safety device, implementing superordinate safety monitoring of all robotic manipulators in said manipulator arrangement; and
allowing configuration of a component of a robotic manipulator by a user, and configuring a further part by a manufacturer to insure a basic predetermined safety functionality of said manipulator independently of user configuration of said part that is configurable by a user.

10. A system for individual safety monitoring of a robotic manipulator, comprising at least one of:
a robotic manipulator and at least one further robotic manipulator;
a safety device configured to communicate with a further control device of the further manipulator, said safety device being configured for superordinate safety monitoring of all robotic manipulators in said system; and
a component that is configurable by a user, and a further part that is configured by a manufacturer to insure a basic predetermined safety functionality of said robotic manipulator independently of user configuration of said part that is configurable by a user.
